(19) United States
(12) Patent Application Publication
(10) Pub. No.: US 2002/0025904 A1
(43) Pub. Date: Feb. 28, 2002

(54) Catalyst carrier holding member, method of making the same and catalyst converter

(76) Inventors: Yoshihiko Goto, Hamamatsu-shi (JP); Toshiyuki Anji, Hamamatsu-shi (JP); Yoshihiro Kawasaki, Hamamatsu-shi (JP); Takashi Onoue, Hamamatsu-shi (JP); Takahiro Niwa, Minato-ku (JP); Masafumi Tanaka, Minato-ku (JP); Syouichi Yonezawa, Nagoya-shi (JP)

Correspondence Address: NIXON & VANDERHYE P.C., 8th Floor, 1100 North Glebe Road, Arlington, VA, 22201-4714, US

(21) Appl. No.: 09/935,163

(22) Filed: Aug. 23, 2001

(30) Foreign Application Priority Data
Aug. 25, 2000 (JP) P2000-255500

(51) Int. Cl. B01J 31/26

(52) U.S. Cl. 502/150; 502/527.16; 428/292.1

(57) ABSTRACT

The present invention provides a catalyst carrier holding member to be fitted into a gap between a catalyst carrier and a casing accommodating the catalyst carrier. The catalyst carrier holding member includes a three-dimensional molded article having flexible inorganic fiber and an inorganic expansive admixture, if desired. The flexible inorganic fiber is bound together by a binder in a compression-deflected state. A surface in contact with the catalyst carrier is shaped substantially in conformity to the outer shape of the catalyst carrier, and a surface in contact with the casing is substantially in conformity to the inner shape of the casing. The catalyst carrier holding member has a thickness equal to or larger than the gap.

### BACKGROUND OF THE INVENTION

1. Field of the Invention

This invention relates to a catalyst carrier holding member used in a catalyst converter for purifying exhaust gases from internal combustion engines, e.g., of automobiles, a method of making the catalyst carrier holding member, and a catalyst converter having the catalyst carrier holding member.

2. Description of the Related Art

A catalyst converter is composed mainly of a catalyst carrier for supporting a catalyst for purifying exhaust gases, such as a honeycomb structure or porous ceramics, a casing for holding the catalyst carrier, and a catalyst carrier holding member which is fitted between the catalyst carrier and the casing to hold the catalyst carrier. The catalyst converter is further composed of a sealing member, etc.

The catalyst carrier holding member is required to have holding properties for fitting in the space without leaving a gap thereby to hold the catalyst carrier securely, cushioning properties for protecting the catalyst carrier from vibrations during running of automobiles, etc., sealing properties for not allowing an exhaust gas to pass therethrough, and heat resistance to the catalyst carrier that is used in high temperature.

For example, JP-A-10-288032 discloses a catalyst carrier holding members comprising an inorganic fiber shaped article composed of a first inorganic fiber mat including a crystalline alumina fiber mat compressed in the thickness direction and an organic binder, and a second inorganic fiber mat including a ceramic fiber mat made of ceramics other than the alumina fiber of the first mat, an inorganic expansive admixture, and an organic binder. Having a non-bulky mat configuration, the shaped article is easy to fit into a casing of a catalyst converter. Having a elastic mat of crystalline alumina fiber, the shaped article holds a catalyst carrier satisfactorily without causing fiber breakage.

However, because of its flat mat shape, it must be rolled around a catalyst carrier and temporarily fixed thereon with adhesive tape, etc. On being press-fitted into a casing, it is very likely that the mat in roll form slides out of the correct position or the adhesive tape is detached. Since the assembly operation is carried out by hand, the finish tends to vary among products, and the yield is low due to fitting failure. Because the series of assembly operation should be done with delicacy, automation is difficult, which has been a bar to cost reduction.

The mat has limited applicability because of its flat shape. That is, the mat is basically applicable only to cylindrical or conical catalyst carriers or casings. When a casing or a catalyst carrier has a complicated shape, for example, when a casing has a tapered or curved section, or when a catalyst carrier has a neck portion, the mat is liable to come in non-uniform contact or fail to contact in parts with the catalyst carrier or the casing, resulting in a failure to hold the catalyst carrier sufficiently. It would follow that the catalyst carrier is broken due to, for example, vibrations during running of automobiles.

The mat has another problem that an inner layer and an outer layer of the inorganic fiber shaped article tend to separate from each other in long-term use due to vibrations, etc., resulting in a reduction of catalyst carrier holding properties. Such layer separation seems to ascribable to difference in physical properties between the inner layer that does not thermally expand and the outer layer that expands with heat. In particular, the improvement in exhaust gas purifying performance of the latest catalyst converters has created an elevated temperature environment. As a result, the outer layer containing an inorganic expansive admixture, which has poor heat resistance, is readier to deteriorate than the inner layer, which accelerates the layer separation.

Considering that a catalyst converter is for purification of exhaust gases, it is desirable to minimize use of organic matter, such as an organic binder, that will pollute exhaust gases.

### SUMMARY OF THE INVENTION

An object of the present invention is to provide a catalyst carrier holding member which exhibits a good fit when assembled with a catalyst carrier and a casing, shows little scatter in assembly finish, and maintains the fit for an extended period of time however complicated the shape of the catalyst carrier or the casing may be, the assembly of which can be automated because of the ease of fitting to bring about cost reduction, and which uses a reduced amount of an organic binder and therefore hardly invites contamination of an exhaust gas with the vaporized or burnt organic binder.

As a result of extensive studies, the present inventors made an inorganic fiber molding comprising a three-dimensional molded article including flexible inorganic fiber and an inorganic expansive admixture, if desired, wherein the flexible inorganic fiber is bound together by a binder in a compression-deflected state. Further, a surface in contact with the catalyst carrier is shaped substantially in conformity to the outer shape of the catalyst carrier, and a surface in contact with the casing is substantially in conformity to the inner shape of the casing, and the catalyst carrier holding member has a thickness equal to or larger than the gap. They have ascertained that the catalyst carrier holding member having the above structure is applicable even to a complicated shape to give a good fit to a catalyst carrier or a casing without scatter in assembly finish thereby keeping holding properties stably for a long period of time. The ease of fitting makes it feasible to automate the assembly operation, which leads to cost reduction. Since the catalyst carrier holding member contains no or a reduced amount of an organic binder, contamination of an exhaust gas with the vaporized or burnt organic binder can be avoided or suppressed. The present invention has been completed based on these findings.

The present invention provides a catalyst carrier holding member to be fitted into a gap between a catalyst carrier and a casing. The catalyst carrier holding member comprises a three-dimensional molded article including flexible inorganic fiber and an expansive admixture, if desired, wherein the flexible inorganic fiber is bound together by a binder in a compression-deflected state, wherein a surface in contact with the catalyst carrier is shaped substantially in conformity to the outer shape of the catalyst carrier, wherein a surface in contact with the casing is substantially in conformity to the inner shape of the casing, and wherein the catalyst carrier holding member has a thickness equal to or larger than the gap.

The present invention also provides a method of making a catalyst carrier holding member. The method comprises: feeding a slurry comprising at least flexible inorganic fiber and a binder and, if desired, an inorganic expansive admixture to a dewatering mold, the contour of which is substantially the same as the outer shape of the catalyst carrier or the inner shape of the casing; dewatering the slurry to deposit a preform on the mold; and shaping the preform into a shaped form wherein a surface in contact with the catalyst carrier is shaped substantially in conformity to the outer shape of the catalyst carrier, and wherein a surface in contact with the casing is substantially in conformity to the inner shape of the casing, and wherein the catalyst carrier holding member has a thickness equal to or larger than the gap.

The present invention also provides a catalyst converter characterized in having the above-described catalyst carrier holding member.

### BRIEF DESCRIPTION OF THE DRAWINGS

FIG. 1 is a schematic perspective of a suction-dewatering mold used in the present invention.

FIG. 2 is a schematic perspective of a catalyst carrier holding member according to the present invention.

FIG. 3 is a cross-section showing the state that the catalyst carrier holding members are fitted between a catalyst carrier and a casing.

### DETAILED DESCRIPTION OF THE PREFERRED EMBODIMENTS

The catalyst carrier holding member according to the invention is an inorganic fiber molding having a threes dimensional structure comprising flexible inorganic fibers having been deflected by compression and bound together with a binder. If desired, the molding can further comprise an inorganic expansive admixture. The term “flexible inorganic fiber” as used herein means an inorganic fiber which is capable of being deflected when bound with a binder among themselves or with an inorganic expansive admixture added if necessary. Such flexible inorganic fiber includes alumina fiber, silica fiber, mullite fiber, aluminosilicate fiber, glass fiber, and rock wool. Alumina fiber is preferred for its excellent flexibility in high temperature. These inorganic fibers can be used either individually or as a combination of two or more kinds thereof.

The flexible inorganic fiber usually has a fiber diameter of 1 to 20 μm, preferably 3 to 7 μm. This range is favorable for holding the balance between flexibility and strength. The flexible inorganic fiber usually has a fiber length of 10 μm to 100 mm, preferably 50 μm to 5 mm. With the fiber length being in this range, the fibers can be bound in a sufficiently deflected state with a reduced amount of a binder, and the fibers get entangled with each other to a moderate degree. Fibers shorter than 10 μm have insufficient flexibility, tending to result in insufficient cushioning properties. A fiber length greater than 100 mm tends to result in too high a repulsive force, i.e., a force of recovery from deflection when the catalyst carrier holding member is used. Too high a repulsive force is apt to break the catalyst carrier, and the amount of the binder may have to be increased to suppress the repulsion. The flexible inorganic fibers can be consisted of one material or combination of two or more materials.

The binder which can be used in the invention includes organic ones and inorganic ones. Organic ones include acrylic resins such as polyacrylamide, starch, emulsions and latex. Latex is preferred for its high flexibility, which is effective in suppressing recovery force of the fibers on use. The organic binder burns away by the heat of the holding member while used. As a result, the flexible inorganic fibers are relieved from the compression-deflected state to produce a recovery force, which is imposed onto the outer side of the catalyst carrier and the inner side of the casing to exhibit excellent catalyst carrier holding performance.

The inorganic binders include colloidal silica, alumina sol, titania sol, and zirconia sol. Alumina sol is preferred for its capability of retaining moderate flexibility after molding. Before being heated, the inorganic binder exerts intermolecular force for binding the individual fibers. On using the catalyst carrier holding member, the binding force is weakened by the heat to separate part of the binder from the fibers. As a result, the flexible inorganic fibers are released from the compression-deflected state, while the degree of release is not so high as is observed with an organic binder, to exert a recovery force to the outer side of the catalyst carrier and the inner side of the casing thereby exhibiting excellent catalyst carrier holding performance. Other part of the inorganic binder that does not separate from the fibers imparts some shape retention to the catalyst carrier holding member. Where an inorganic binder is used, an organic flocculant, which may be added to the molding material), is the only organic matter that could be present in the holding member. Therefore, contamination of an exhaust gas with organic matter hardly occurs.

The binders, either organic or inorganic, can be used individually or as a combination of two or more thereof. In particular, a combination of an organic binder and an inorganic binder is advantageous for attaining a balance between shape retention on fitting and shape retention during use.

A mixed amount of the binders is prescribed for each of an organic binder and an inorganic binder. In using an organic binder alone, it is usually used in an amount of 1 to 10 parts by weight, preferably 1 to 3 parts by weight, per 100 parts by weight of the flexible inorganic fiber. An amount less than 1 part results in insufficient binding of the fibers. An amount more than 10 parts will furnish a source of a contaminant to exhaust gases.

The above recited amount of the organic binder is smaller than needed where a compressive force by, for example, dewatering by suction is not applied to the flexible inorganic fiber. While the reason of this is not clear, it is assumed that compression brings the individual fibers closer and increases the contact points among them so that the binding action of the organic binder may be manifested more effectively. An organic binder is lost to some extent through vaporization or burning by the heat during use of the catalyst converter. Accordingly, the amount of the organic binder as recited herein denotes the amount present when the catalyst carrier holding member is fitted in a casing, i.e., before it is heated.

Where an inorganic binder is used alone, it is usually used in an amount of 1 to 10 parts by weight, preferably 1 to 3 parts by weight, per 100 parts by weight of the flexible inorganic fiber. An amount less than 1 part results in insufficient binding of the fibers. Where the amount exceeds 10 parts, the flexible inorganic fibers in the compression-deflected state are inhibited from producing a sufficient recovery force.

Where an organic binder and an inorganic binder are used in combination, each of them is usually used in amount of 1 to 10 parts by weight, preferably 1 to 3 parts by weight, per 100 parts by weight of the flexible inorganic fiber. Out of these ranges, the above-mentioned disadvantages result.

The catalyst carrier holding member can further comprise an inorganic expansive admixture. The inorganic expansive admixture which can be used in the invention includes vermiculite, bloating clay, expansible shale, and expansible graphite. Vermiculite is preferred for its inexpensiveness and a high expansion ratio. The expansive admixture expands by the heat during use of the catalyst carrier holding member to produce pressing force, which further improves the catalyst carrier holding properties.

The amount of the inorganic expansive admixture is, if used, usually 10 to 200 parts by weight, preferably 100 to 200 parts by weight, per 100 parts by weight of the flexible inorganic fiber.

If desired, the catalyst carrier holding member can furthermore comprise an organic or inorganic flocculent, a dispersant, a surface active agent, a fixing agent, a pH adjusting agent, and so forth.

Methods for making the three-dimensional structure of the catalyst carrier holding member of the present invention, in which flexible inorganic fibers are in a compression-deflected state and bound among themselves and with an inorganic expansive admixture, if added, via a binder, include the following. However, methods according to the present invention are not limited to the following.

a wet molding method comprising dewatering a slurry including flexible inorganic fiber, a binder, and, if desired, an inorganic expansive admixture and, if desired, a flocculant to obtain a preform, and drying the preform at an appropriate temperature. If the binder is an organic binder, the drying temperature is selected so as not to burn the organic binder,

a wet molding method comprising dewatering a slurry including flexible inorganic fiber, a binder, and, if desired, an inorganic expansive admixture and, if desired, a flocculant to obtain a preform, compressing the preform to a prescribed density, and drying the preform at an appropriate temperature. If the binder is an organic binder, the drying temperature is selected so as not to burn the organic binder.

a dry molding method comprising uniformly dry-mixing flexible inorganic fiber, a binder and, if desired, an inorganic expansive admixture and dry-pressing the mixture.

a method comprising dry or wet molding a mixture of flexible inorganic fiber, a flocculant and, if desired, an inorganic expansive admixture into a preform without a binder, impregnating the preform with a liquid binder by spraying or dipping, and drying the impregnated preform at an appropriate temperature. If the binder is an organic binder, the drying temperature is selected so as not to burn the organic binder.

The inorganic fiber molding having the three-dimensional structure in which flexible inorganic fibers are bound with an organic binder usually has an apparent density of 0.1 to 0.5 g/cm³, preferably 0.1 to 0.2 g/cm³, before being fitted. The density after fitting is preferably 0.2 to 0.4 g/cm³.

The catalyst carrier holding member according to the present invention is fitted between a catalyst carrier and a casing for accommodating the catalyst carrier holding member. The catalyst carrier holding member is composed of the inorganic fiber molding. The catalyst carrier holding member has its inner side molded substantially to the outer shape of a catalyst carrier and its outer side molded substantially to the inner shape of a casing. Further, the catalyst carrier holding member has a thickness equal to or larger than the gap between the catalyst carrier and the casing. Such a configuration of the catalyst carrier holding member can be obtained by, for example, dewatering the slurry comprising the flexible fiber, etc. by use of a dewatering mold which is shaped in conformity to the contour of a catalyst carrier to be held or to the inner shape of a casing in which the holding member is to be fitted, shaping a wet preform deposited on the dewatering mold into the above-described configuration, and drying the shaped preform. As noted above, where the binder is an organic binder, the drying temperature is selected so as not to burn the organic binder. Where dewatering is carried out without using a dewatering mold, the accumulated fiber aggregate, i.e., a preform is dried and then machined into the above-described configuration.

To facilitate fitting on a catalyst carrier and in a casing, it is a preferred embodiment that the catalyst carrier holding member be slit or split into two or more parts. The slit is widened to make an opening through which the catalyst carrier can be fitted in with ease. A catalyst carrier holding member made up of, for example, axially divided halves is easy to fit on the catalyst carrier. Where the outer diameter of a catalyst carrier fitted into the holding member is slightly larger than the inner diameter of the latter, the slit is not closed tight to leave a gap, or the parting faces may leave a gap therebetween. In such a case, if the slit or the parting line is straight from the gas inlet side to the gas outlet side, exhaust may pass through the gap without passing through the catalyst carrier. Therefore, the slit or the parting line preferably forms the shape of teeth of a saw (a zigzag line) or teeth of a gear or any other form other than a straight line so as not to allow a exhaust gas to pass therethrough. Slitting or splitting the holding member can be performed either simultaneously with or after molding.

The catalyst carrier holding member of the invention has its inner side molded substantially to the outer shape of a catalyst carrier and its outer side molded substantially to the inner shape of a casing and has a thickness equal to or larger than the gap between the catalyst carrier and the casing. Upon use, the organic binder is vaporized or burned away by heat, or part of the inorganic binder loses its bonding by heat application, thereby relieving the flexible inorganic fibers from restraint. It follows that the individual flexible inorganic fibers show recovery from the deflected state and, as a whole, press the catalyst carrier inward and the casing outward. Accordingly, the holding member exhibits a good fit, shows little scatter in assembly finish, and maintains the fit for an extended period of time however complicated the shape of the catalyst carrier or the casing may be. The ease of fitting makes it feasible to automate the fitting operation, which leads to cost reduction. Even where an organic binder is used, the amount of the organic binder is minimized so that contamination of an exhaust gas with the evaporated or burnt organic binder can be suppressed.

The catalyst carrier holding member of the invention can have a multilayer structure composed of two or more layers different in composition which are superposed on each other in the thickness direction. The multilayer structure includes a three-layered structure composed of: an inorganic fiber layer having a three-dimensional structure in which flexible inorganic fibers are bound with an inorganic binder in a compression-deflected state as an inner layer (a layer to be brought into contact with a catalyst carrier); an inorganic fiber layer having a three-dimensional structure in which flexible inorganic fibers are bound with an organic binder, an inorganic binder, and an inorganic expansive admixture in a compression-deflected state as an intermediate layer; and an inorganic fiber layer having a three-dimensional structure in which flexible inorganic fibers are bound with an organic binder and an inorganic expansive admixture in a compression-deflected state as an outer layer (a layer to be brought into contact with a casing). In this embodiment, the inner layer and the intermediate layer are similar in composition, and the outer layer and the intermediate layer are similar in composition. As a result, the multilayer structure hardly undergoes layer separation and resultant positional deviation during use.

Each layer making up the multilayer structure is designed to satisfy the respectively required characteristics. For example, non-reactivity with a catalyst carrier is required of the inner layer, an inorganic fiber layer having little organic matter, i.e., a composition comprising flexible inorganic fiber and an inorganic binder is desirable. Where the outer layer is required to have a holding properties or cushioning properties, an inorganic fiber layer comprising flexible inorganic fiber, an organic binder and an inorganic expansive admixture is suitable. The intermediate layer preferably has a composition similar to both the composition of the inner layer and that of the outer layer so as to minimize discontinuity in composition or physical properties from the inner layer to the outer layer.

The catalyst carrier holding member having a multilayer structure, for example, the above-described three-layered structure can be obtained by, for example, feeding a first slurry containing flexible inorganic fiber and an inorganic binder to a dewatering mold whose contour is substantially the same as the contour of a catalyst carrier to deposit a first fiber layer on the dewatering mold by dewatering, feeding a second slurry containing flexible inorganic fiber, an organic binder, an inorganic binder, and an inorganic expansive admixture to the dewatering mold to deposit a second fiber layer on the first fiber layer, feeding a third slurry containing flexible inorganic fiber, an organic binder, and an inorganic expansive admixture to the dewatering mold to deposit a third fiber layer on the second fiber layer to form a three-layered preform. Alternately, the three-layered structure can be prepared by using a dewatering mold whose contour is substantially the same as the inner shape of a casing. In this case, the slurries are fed in the order of the third slurry, the second slurry and the first slurry.

The catalyst carrier holding member can have its composition varied continuously in the thickness direction. The language “varied continuously” as used herein means that there is no discontinuity in composition in the thickness direction. Accordingly, the catalyst carrier holding member having its composition varied continuously may have a portion having an unchanged composition over a certain thickness, namely, a portion that can be regarded as a layer. A typical example of such a structure comprises: an inorganic fiber portion having a three-dimensional structure in which flexible inorganic fibers are bound with an organic binder in a compression-deflected state as an inner portion; an inorganic fiber portion having a three-dimensional structure in which flexible inorganic fibers are bound with an organic binder and an inorganic expansive admixture in a compression-deflected state as an outer portion; and an inorganic fiber portion connecting the inner portion and the outer portion with its composition varied continuously from the composition of the inner portion to the composition of the outer portion so that there is no distinct borders of layers. In this embodiment, the catalyst carrier holding member hardly undergoes layer separation and resultant positional deviation during use.

The catalyst carrier holding member having a continuously varied composition as described above can be obtained by, for example, feeding a first slurry containing flexible inorganic fiber and an organic binder to a dewatering mold whose contour is substantially the same as the contour of a catalyst carrier to deposit an inner fiber portion and then gradually changing the composition of the slurry to be fed to the composition of a second slurry for forming an outer portion which comprises flexible inorganic fiber, an organic binder, and an inorganic expansive admixture to form an intermediate portion having its composition gradually varied from that of the first slurry to that of the second slurry, and finally feeding the second slurry to form an outer portion. Alternately, a dewatering mold whose contour is substantially the same as the inner shape of a casing can be used. In this case, the second slurry is the first to be fed, and the slurry composition is gradually changed to that of the first slurry.

The method of making a catalyst carrier holding member according to the present invention will then be described. The method according to the present invention comprises feeding a slurry comprising flexible inorganic fiber and a binder and, if desired, an inorganic expansive admixture to a mold for dewatering the contour of which is substantially the same as the outer shape of a catalyst carrier or the inner shape of a casing, dewatering the slurry to deposit a preform on the mold, and shaping the preform into a shaped form having the inner side thereof substantially conforming to the outer shape of the catalyst carrier and the outer side thereof substantially conforming to the inner shape of the casing and having a thickness equal to or larger than the gap between the catalyst carrier and the casing.

The dewatering mold includes a net of wire whose contour is substantially the same as the contour of the catalyst carrier or the inner shape of the casing. In order to facilitate removal of a preform from the mold or to make a slit or split preform, the dewatering mold can have at least one fin-like thin projection. In making a slit or split preform, the cross-section of the thin projection preferably has the same shape as a designed slit or designed parting lines.

When a dewatering mold whose contour is substantially the same as that of a catalyst carrier, the preform as deposited on the dewatering mold can be shaped by pressing with a shaping mold whose inner shape is substantially the same as that of a casing. When a dewatering mold whose contour is substantially the same as the inner shape of a casing, the preform as deposited on the dewatering mold can be shaped by pressing with a shaping mold whose contour is substantially the same as that of a catalyst carrier. The shaping molds for pressing the preform include those made of a wire or a plate. The shaping mold can be used in combination with the dewatering mold while the slurry is dewatered to deposit a fiber layer, or after completion of forming a preform.

The slurry comprises materials making up the catalyst carrier holding member, i.e., at least flexible inorganic fiber and a binder. The slurry can contain, if desired, an inorganic expansive admixture. As previously stated, the binder includes an organic binder, an inorganic binder, and a mixture thereof. The slurry can further contain at least one flocculant for flocculating the solid matter of the slurry. The mixing ration of the flexible inorganic fiber, the binder, and the inorganic expansive admixture is decided appropriately according to a designed composition of the catalyst carrier holding member.

Conditions for dewatering are not particularly limited. For example, where dewatering is carried out by spontaneous drainage, the concentration of the slurry is adjusted to give a desired density. Where dewatering is conducted by suction, the pressure of suction as well as the slurry concentration are adjusted to give a desired density. Where dewatering is performed by compression, the compressive force as well as the slurry concentration are adjusted according to a desired density.

After dewatering, the resulting preform is shaped to have a smooth surface, if necessary, by means of a shaping mold, removed from the dewatering mold, and dried. Drying conditions are not particularly limited as far as the water content of the wet preform is sufficiently removed. For instance, drying is carried out at 50 to 200° C., preferably 80 to 110° C., for 1 to 96 hours, preferably 8 to 24 hours.

A catalyst carrier holding member having a multilayer structure can be prepared by following the method of the invention. For example, a three-layered structure can be obtained as follows. A dewatering mold whose contour is substantially the same as the contour of a catalyst carrier is put in a first slurry tank filled with a first slurry containing flexible inorganic fiber and an inorganic binder to deposit a first fiber layer (inner layer) on the dewatering mold by dewatering. The dewatering mold having the first fiber layer deposited thereon is taken out of the first slurry tank and put in a second slurry tank filled with a second slurry containing flexible inorganic fiber, an organic binder, an inorganic binder, and an inorganic expansive admixture to deposit a second fiber layer (intermediate layer) on the first fiber layer by dewatering. The dewatering mold having the first fiber layer and the second fiber layer deposited thereon is taken out of the second slurry tank and put in a third slurry tank filled with a third slurry containing flexible inorganic fiber, an organic binder, and an inorganic expansive admixture to deposit a third fiber layer (outer layer) on the second fiber layer to form a three-layered preform. The dewatering mold having the three-layered preform is taken out of the third slurry tank, shaped if necessary, removed from the dewatering mold, and dried. When a dewatering mold whose contour is substantially the same as the inner shape of a casing is used, a three-layered preform is formed in the same manner as described above, except for using the three slurries in a reversed order.

The multilayer catalyst carrier holding member thus prepared has an inner layer, an intermediate layer and an outer layer in this order from the side to be brought into contact with a catalyst carrier. The inner layer and the outer layer can be designed to have characteristics suited to the respective positions thereby to exhibit sufficient properties as a catalyst carrier holding member, such as cushioning properties and shape retention. Where the intermediate layer is designed to have a composition similar to both the composition of the inner layer and that of the outer layer, discontinuity among the constituent layers in composition and physical properties is minimized so that layer separation can be prevented.

A catalyst carrier holding member having the composition varied continuously in its thickness direction can also be prepared by following the method of the invention in which the composition of the slurry to be fed is varied gradually. For example, a dewatering mold whose contour is substantially the same as the contour of a catalyst carrier is put in a slurry tank filled with a first slurry containing flexible inorganic fiber and an organic binder to deposit a fiber layer serving as an inner portion by dewatering. Then, the composition of the slurry to be fed to the tank is gradually changed from the composition of the first slurry toward that of a second slurry for forming an outer portion which comprises flexible inorganic fiber, an organic binder, and an inorganic expansive admixture, and finally the tank is filled with the second slurry to form a preform having an inner portion made from the first slurry, an intermediate portion whose composition gradually changes from that of the first slurry to that of the second slurry, and an outer portion made from the second slurry. The dewatering mold having the preform deposited thereon is taken out of the tank, shaped if necessary, removed from the mold, and dried. When a dewatering mold whose contour is substantially the same as the inner shape of a casing is used, a preform having the above-described composition variation is obtained in the same manner as described above, except for using the two slurries in a reversed order.

The inner portion and the outer portion constituting the catalyst carrier holding member having its composition varied continuously can be designed to have characteristics suited to the respective positions thereby to exhibit sufficient properties as a catalyst carrier holding member, such as cushioning properties and shape retention. Since there is no distinct borders between the inner portion and the outer portion owing to the intermediate portion having a compositional gradient, layer separation arising from discontinuity in composition and physical properties hardly occur.

The catalyst converter according to the present invention comprises the catalyst carrier holding member of the present invention, a catalyst carrier, and a casing. The catalyst converter is easily assembled by fitting the catalyst carrier holding member between the catalyst carrier and the casing by hand. Since the catalyst carrier holding member is shaped to the contour of the catalyst carrier on one side thereof and to the inner shape of the casing on the other side thereof and has a thickness equal to or larger than the gap between the casing and the catalyst carrier, it closely and easily fits the gap between the casing and the catalyst carrier on assembly. Thus, assembly of the catalyst converter, which has been performed manually, can be automated to realize cost reduction. Additionally, the amount of the organic binder can be reduced to minimize contamination of exhaust gases.

The catalyst carrier holding member of the invention is useful in a catalyst converter for, for example, purifying automobile exhaust gases.

### EXAMPLE

The present invention will now be illustrated in greater detail with reference to Example, but it should be understood that the invention is not construed as being limited thereto.

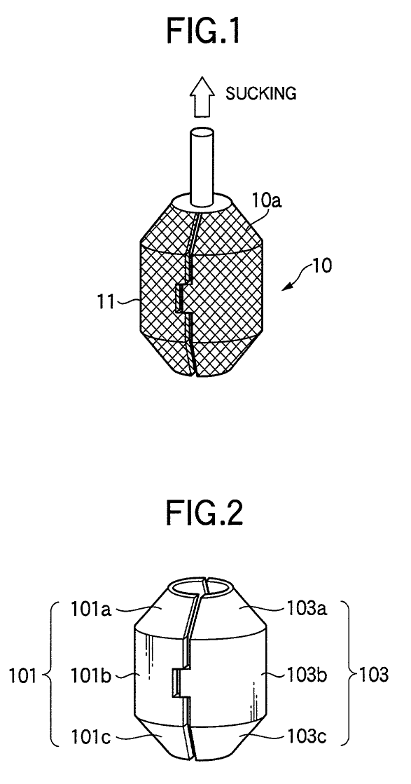

A suction-dewatering mold 10 shown in FIG. 1 was prepared. The mold 10 has a wire net 10a shaped in conformity to the contour of a catalyst carrier and having fins 11 1sticking out from its outer surface to make slits in an angular U-shape. The mold 10 exerts suction from the outside toward the inside through the wire net 10a.

Alumina fiber (97 parts) having an Al₂O₃ content of 72% and an SiO₂ content of 28%, of which fiber length is 3 mm and a fiber diameter is 3 μm, and 3 parts of latex were mixed in water, and 0.1 part of a nonionic flocculant was added thereto to prepare a slurry having a solid content of 2%.

The dewatering mold 10 was immersed in the slurry, and the slurry was sucked up to deposit the fiber on the mold 10 to form a preform. The mold 10 was taken out of the slurry, and the preform was removed from the mold 10 and dried at 105° C. for 12 hours to obtain a catalyst carrier holding member split into two halves 101 and 103 as shown in FIG. 2.

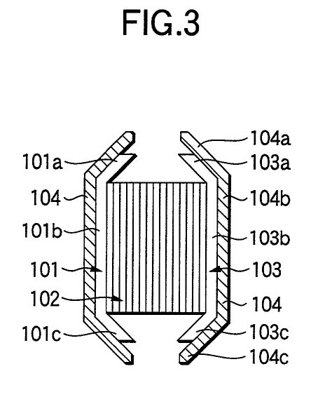

FIG. 3 is a cross-section of which the catalyst carrier holding member 101 and 103 are fitted between a catalyst carrier 102 and a casing 104. The halves 101 and 103 are symmetrical except for their parting faces, each having a body section 101b or 103b and tapered sections 101a or 103a and 101c or 103c on the upper and the lower ends of the body section 101b or 103b, respectively. As a result, the two halves 101 and 103, when joined together, get narrower in the upper and the lower tapered sections than in the body section. The contour of the upper and the lower tapered sections (101a 103a, 101c and 103c) agrees with the inner shape of the tapered sections 104a and 104c of the casing 104, and the axial length of the body sections 101b and 103b agrees with the length of the catalyst carrier 102. Therefore, the catalyst carrier 102 held in the holding member is prevented from moving in the axial direction. Since the contour of the joined halves 101 and 103 is substantially the same as the inner shape of the casing 104, they are restrained by the casing 104. As a result, the catalyst carrier 102 held in the holding member is restrained from moving both in the axial direction and in the radial direction.

According to the present invention, the catalyst carrier holding member exhibits a good fit when assembled with a catalyst carrier and a casing, shows little scatter in assembly finish, and maintains the fit for an extended period of time however complicated the shape of the catalyst carrier or the casing may be. The ease of fitting makes it feasible to automate the assembly operation, which leads to cost reduction. Since an organic binder is not at all needed, or used in a reduced amount, contamination of an exhaust gas with the evaporated or burnt organic binder can be avoided or suppressed.

Where the catalyst carrier holding member has a multilayer structure composed of two or more layers different in composition or a structure having the composition varied continuously in the thickness direction, the holding member has, in addition to the above-mentioned effects, the advantage that the inner layer or portion shows improved contact with the catalyst carrier, and the outer layer or portion exhibits improved cushioning properties against the casing while having no discontinuity of composition or physical properties in the thickness direction.

The catalyst carrier holding member according to the present invention can be prepared by dewatering a slurry comprising flexible inorganic fiber and a binder and, if desired, an inorganic expansive admixture to deposit a fiber preform on a dewatering mold whose contour is substantially the same as the contour of a catalyst carrier or the inner shape of a casing. In this method, the individual flexible inorganic fibers can be bound together in a compressed state even with a reduced content of organic matter. By changing the composition of the slurry to be fed, it is possible to build up a preform with its inner side and outer side having different compositions suited to the respective desired characteristics. The catalyst carrier holding member having a multilayered structure or having the composition varied continuously in the thickness direction undergoes little layer separation and exhibits excellent holding properties stably for a prolonged period of time.

What is claimed is:

1. A catalyst carrier holding member to be fitted into a gap between a catalyst carrier and a casing accommodating the catalyst carrier, said catalyst carrier holding member comprising:
a three-dimensional molded article including flexible inorganic fiber bound by a binder in a compression-deflected state,
wherein a surface in contact with the catalyst carrier is shaped substantially in conformity to an outer shape of the catalyst carrier,
wherein a surface in contact with the casing is substantially in conformity to an inner shape of the casing, and
wherein said catalyst carrier holding member has a thickness equal to or larger than the gap.

2. The catalyst carrier holding member according to claim 1, wherein said molded article further includes an inorganic expansive admixture.

3. The catalyst carrier holding member according to claim 1, wherein a multilayer structure including at least two layers different in composition is provided from the surface in contact with the catalyst carrier to the surface in contact with the casing.

4. The catalyst carrier holding member according to claim 1, wherein a composition of said catalyst carrier holding member varies continuously from the surface in contact with said catalyst carrier to the surface in contact with said casing.

5. The catalyst carrier holding member according to claim 1, wherein said binder includes an organic binder in an amount of 1 to 10 parts by weight per 100 parts by weight of said flexible inorganic fiber.

6. The catalyst carrier holding member according to claim 1, wherein said binder includes an inorganic binder in an amount of 1 to 10 parts by weight per 100 parts by weight of said flexible inorganic fiber.

7. The catalyst carrier holding member according to claim 1, wherein said binder includes an organic binder and an inorganic binder, and each of said organic binder and said inorganic binder is included in an amount of 1 to 10 parts by weight per 100 parts by weight of said flexible inorganic fiber.

8. The catalyst carrier holding member according to claim 1, wherein said flexible inorganic fiber has a fiber length of 10 μm to 100 mm.

9. The catalyst carrier holding member according to claim 1, said catalyst carrier holding member is obtained by molding with dewatering.

10. The catalyst carrier holding member according to claim 1, further comprising a slit penetrating from the surface in contact with the catalyst carrier to the surface in contact with the casing.

11. The catalyst carrier holding member according to claim 1, wherein said catalyst carrier holding member is divided into at least two parts.

12. A method for making a catalyst carrier holding member, comprising:
feeding a slurry comprising flexible inorganic fiber and a binder to a dewatering mold, the contour of which is substantially the same as one of an outer shape of a catalyst carrier and an inner shape of a casing;
dewatering the slurry to deposit a preform on the mold; and
shaping the preform into a shaped form, wherein a surface in contact with the catalyst carrier is shaped substantially in conformity to the outer shape of the catalyst carrier, and wherein a surface in contact with the casing is substantially in conformity to the inner shape of the casing, and wherein the catalyst carrier holding member has a thickness equal to or larger than a gap between the catalyst carrier and the casing accommodating the catalyst carrier.

13. The method for making a catalyst carrier holding member according to claim 12, wherein the slurry further comprises an inorganic expansive admixture.

14. The method for making a catalyst carrier holding member according to claim 12, wherein a plurality of slurries different in composition are used successively during feeding and dewatering the slurry to obtain the catalyst carrier holding member including a multilayer structure having two or more layers different in composition and provided from the surface in contact with the catalyst carrier to the surface in contact with the casing.

15. The method for making a catalyst carrier holding member according to claim 12, wherein the composition of the slurry is varied during feeding and dewatering the slurry to obtain the catalyst carrier holding member of which the composition varies continuously from the surface in contact with the catalyst carrier to the surface in contact with the casing.

16. A catalyst converter comprising a catalyst carrier holding member,
wherein said catalyst carrier holding member is fitted into a gap between a catalyst carrier and a casing accommodating the catalyst carrier, and
wherein said catalyst carrier holding member comprises:
a three-dimensional molded article including flexible inorganic fiber bound by a binder in a compression-deflected state,
wherein a surface in contact with the catalyst carrier is shaped substantially in conformity to an outer shape of the catalyst carrier,
wherein a surface in contact with the casing is substantially in conformity to an inner shape of the casing, and
wherein said catalyst carrier holding member has a thickness equal to or larger than the gap.
